(19) United States
(12) Patent Application Publication
(10) Pub. No.: US 2026/0093431 A1
(43) Pub. Date: Apr. 2, 2026

(54) Method for selecting from plurality of input signals to determine output signal for external device and display for performing the method

(71) Applicant: REALTEK SEMICONDUCTOR CORPORATION, HSINCHU (TW)

(72) Inventors: CHUN-HUA WANG, HSINCHU (TW); CHENG-HUNG WU, HSINCHU (TW)

(21) Appl. No.: 19/272,586

(22) Filed: Jul. 17, 2025

(30) Foreign Application Priority Data
Oct. 1, 2024 (TW) 113137665

(51) Int. Cl. G06F 3/14; G06F 3/147

(52) U.S. Cl. CPC G06F 3/1423; G06F 3/1407; G06F 3/147

(57) ABSTRACT

A method, performed by a display, for selecting from multiple input signals to output an output signal to another display comprises: receiving the multiple input signals with multiple input ports of the display respectively, and receiving a user command designating a first input signal of the multiple input signals as a selected signal to be or to be converted into the output signal; determining whether the display is displaying frame(s) according to the selected signal, and if so, executing output steps. The output steps include: when a bandwidth of an output port of the display is enough, setting a signal outputting circuit of the display according to a format of the selected signal and a specification of the output port coupled to the external device; and using the signal outputting circuit to output the output signal to the output port according to the selected signal.

### BACKGROUND OF THE INVENTION

### 1. Field of the Invention

The present disclosure relates to selecting an output signal, especially to a method for selecting from a plurality of input signals to determine an output signal for an external device and a display for performing the method.

### 2. Description of Related Art

Generally, a display (hereinafter referred to as “display A”) having a plurality of input ports and an output port can receive a plurality of video/audio input signals with the plurality of input ports and then select a video/audio input signal (hereinafter referred to as “local video/audio input signal”) from the plurality of video/audio input signals by an on-screen display (OSD) function so as to show frames on the screen of the display A according to the local video/audio input signal. The display A can output the local video/audio input signal to another display (hereinafter referred to as “display B”) through the output port so that the display B can display the same frames on its screen. It is noted that the display A cannot independently select another video/audio input signal different from the local video/audio input signal to output it to the display B; in other words, the display A can only make the selection for itself, but not for the display B.

In light of the above, when the local video/audio input signal is interrupted, the display A will stop outputting the local video/audio input signal and will not select any other video/audio input signals to output it to the display B.

### SUMMARY OF THE INVENTION

One of the objectives of the present disclosure is to introduce a method for selecting from a plurality of input signals to determine an output signal for an external device and a display for performing the method.

An embodiment of the method of the present disclosure is based on a user command and is performed by a display. This embodiment includes the following steps: receiving a plurality of input signals with a plurality of input ports of the display respectively, and receiving a user command designating a first input signal of the plurality of input signals as a selected signal to be or to be converted into an output signal; determining whether the display is displaying frame(s) according to the selected signal; and responsive to determining that the display is displaying the frame(s) according to the selected signal, executing at least one output step. The at least one output step includes: in a circumstance that the bandwidth of an output port of the display is enough, setting a signal outputting circuit of the display according to a format of the selected signal and a specification of the output port, wherein the output port is configured to be physically coupled to an external device; and after the setting of the signal outputting circuit, using the signal outputting circuit to output the output signal to the external device through the output port according to the selected signal.

Another embodiment of the method of the present disclosure is based on a default rule and is performed by a display. This embodiment includes the following steps: receiving a plurality of input signals with a plurality of input ports of the display respectively, and automatically selecting a first input signal from the plurality of input signals as a selected signal to be or to be converted into the output signal under the default rule; determining whether the display is displaying frame(s) according to the selected signal; and responsive to determining that the display is displaying the frame(s) according to the selected signal, executing at least one output step. The at least one output steps includes: in a circumstance that the bandwidth of an output port of the display is enough, setting a signal outputting circuit according to a format of the selected signal and a specification of the output port, wherein the output port is configured to be physically coupled to an external device; using the signal outputting circuit to output the output signal to the external device through the output port according to the selected signal; detecting whether the plurality of input signals is updated because the first input signal (i.e., the previously selected signal) is removed or a new input signal is received by the display, and accordingly generating a change-detection result; when the change-detection result indicates that the plurality of input signals is not updated, making the signal outputting circuit keep outputting the output signal to the output port according to the selected signal; and when the change-detection result indicates that the plurality of input signals is updated, going back to the step of receiving the plurality of input signals and automatically selecting from the plurality of input signals under the default rule.

An embodiment of the display of the present disclosure includes: N input ports configured to receive N input signals respectively, wherein the N is an integer equal to or greater than two; at least one output port including a first output port, wherein the first output port is configured to be physically coupled to an external device; K N-to-1 multiplexers coupled to the N input ports and configured to select X input signal(s) from the N input signals, wherein the K is an integer equal to or greater than two, and the X is a positive integer equal to or less than the N; K signal processing circuits coupled to the K N-to-1 multiplexers respectively and configured to process the X input signal(s) to generate X signal(s), wherein the X signal(s) include(s) (X−1) locally-applied signal(s) and a selected signal that is used as the output signal or the material for generating the output signal; (M+1) K-to-1 multiplexers coupled to the K signal processing circuits, the (M+1) K-to-1 multiplexers configured to output the (X−1) locally-applied signal(s) to (X−1) signal displaying circuit(s) of M signal displaying circuit(s) of the display and the (M+1) K-to-1 multiplexers further configured to output the selected signal to a signal outputting circuit of the display, wherein the M is a positive integer; the M signal displaying circuit(s) including the (X−1) signal displaying circuit(s), wherein the (X−1) signal displaying circuit(s) is/are configured to show frame(s) on a screen of the display according to the (X−1) locally-applied signal(s); the signal outputting circuit configured to output the output signal to the external device through the first output port according to the selected signal; and a control circuit configured to control the K N-to-1 multiplexers and the (M+1) K-to-1 multiplexers according to a user command or a default rule and thereby select one of the N input signals as the selected signal to be or to be converted into the output signal.

These and other objectives of the present invention will no doubt become obvious to those of ordinary skill in the art after reading the following detailed description of the preferred embodiments that are illustrated in the various figures and drawings.

### BRIEF DESCRIPTION OF THE DRAWINGS

FIG. 1 shows the result of an embodiment of the present invention.

FIG. 2 shows an embodiment of the method of the present disclosure.

FIG. 3 shows another embodiment of the method of the present disclosure.

FIG. 4 shows an embodiment of the display of the present disclosure.

### DETAILED DESCRIPTION OF THE PREFERRED EMBODIMENTS

The present specification discloses a method for selecting from a plurality of input signals (e.g., video or audio signals) to determine an output signal for an external device; furthermore, the present specification discloses a display for performing the method. The external device is another display or a video or audio player (e.g., a projector or a speaker) capable of using the output signal.

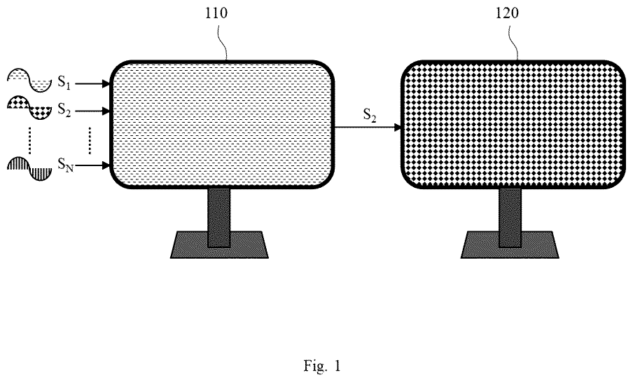

FIG. 1 illustrates the result of an embodiment of the present invention. FIG. 1 shows a first display 110 and a second display 120, wherein the first display 110 is configured to perform the present invention and the second display 120 is an external device to the first display 110. The first display 110 receives N input signals S₁˜S_{N} with N input ports (not shown in FIG. 1) respectively, and then selects an input signal from the N input signals S₁˜S_{N} as a locally-applied signal S_{I} and selects an input signal from the N input signals S₁˜S_{N} as a selected signal S_{J} to be or to be converted into an output signal. The first display 110 displays frame(s) according to the locally-applied signal S_{I} (e.g., S₁), and outputs the output signal to the second display 120 through an output port (not shown in FIG. 1) of the first display 110 according to the selected signal S_{J} (e.g., S₂), wherein the N is an integer greater than one, the I and the J are positive integers equal to or less than the N, the I is different from the J, and the selected signal S_{J} is directly used as the output signal or is processed and then used as the output signal. The second display 120 displays frames according to the output signal. As can be seen from FIG. 1, in addition to selecting the locally-applied signal S_{I}, the present invention can independently select the selected signal S_{J} to be or to be converted into the output signal; furthermore, the present invention allows the selected signal S_{J} to be different from the locally-applied signal S_{I}. In FIG. 1, different sine wave patterns indicate that different input signals have different contents to be displayed.

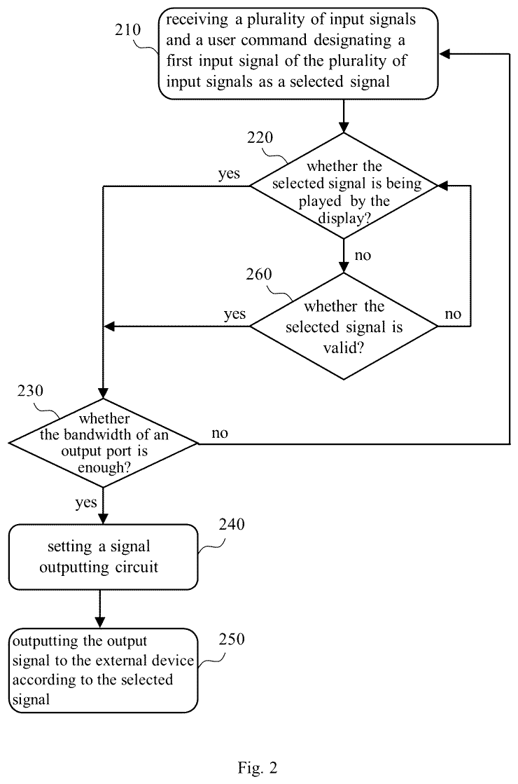

FIG. 2 shows an embodiment of the method of the present disclosure. This embodiment is performed by a display (e.g., the first display 110 in FIG. 1), which can independently select from a plurality of input signals (e.g., the N input signals S₁˜S_{N} in FIG. 1) to output an output signal (e.g., S₂ in FIG. 1) to an external device (e.g., the second display 120 in FIG. 1). As shown in FIG. 2, this embodiment includes the following steps:
S210: receiving the plurality of input signals with a plurality of input ports of the display respectively and receiving a user command designating a first input signal of the plurality of input signals as a selected signal to be or to be converted into the output signal.
   In an implementation example, the user command is generated by a user using an on-screen display (OSD) function of the display or using at least one physical shortcut key or button, or the user command is generated by a user using a source control method (e.g., a personal computer connected to the display).
S220: determining whether the selected signal is being played by the display; if so, going to step S230; if not, going to step S260.
S230: determining whether a bandwidth of an output port of the display is enough, wherein the output port is configured to be physically coupled to the external device; if so, going to step S240; if not, going to step S210.
   It is noted that in some circumstances (e.g., a circumstance that the plurality of input signals is properly filtered or the bandwidth of the output port meets the maximum bandwidth requirement), step S230 may be omitted, that is, step S230 mentioned in the other steps in FIG. 2 should be replaced by step S240.
S240: setting a signal outputting circuit according to a format of the selected signal and a specification of the output port.
S250: after the setting of the signal outputting circuit, using the signal outputting circuit to output the output signal to the external device through the output port according to the selected signal.
   Depending on implementation needs, the output signal may be the selected signal, or a signal generated by the signal outputting circuit processing the selected signal.
S260: determining whether the selected signal is valid; if so, going to step S230; if not, going to step S220.
   For example, this step detects whether the pattern of the selected signal matches a predetermined pattern to determine whether the selected signal is valid.
   For example, this step uses a hardware circuit to detect the selected signal and generates a validity-detection result indicating whether the selected signal is valid. For example, the above-mentioned hardware circuit is a spare circuit among a plurality of hardware circuits of the display.
   It is noted that the validity of the selected signal may be invalid in the early stage due to signal instability or other factors, but it may be deemed valid in the later stage.
      It is noted that each step in FIG. 2 alone can be implemented by known or self-developed technologies, and thus its details are omitted here to avoid redundancy.

Referring to FIG. 2, in an implementation example, the first input signal is received by the display through a first input port of the plurality of input ports, and the type of the first input port (e.g., High Definition Multimedia Interface (HDMI)) is different from the type of the output port (e.g., DisplayPort (DP)). In an implementation example, when the type of the first input port is different from the type of the output port, step S240 further includes: converting the format of the first input signal (i.e., the selected signal) to generate the output signal conforming to the type of the output port. In an implementation example, the type of the first input port is the same as the type of the output port. In an implementation example, when it is determined that the bandwidth of the output port is insufficient, in at least one of steps S230 to S250 a signal processing circuit of the display is used to process the selected signal to make it comply with the bandwidth specification of the output port; in this implementation example, step S230 does not need to go back to step S210.

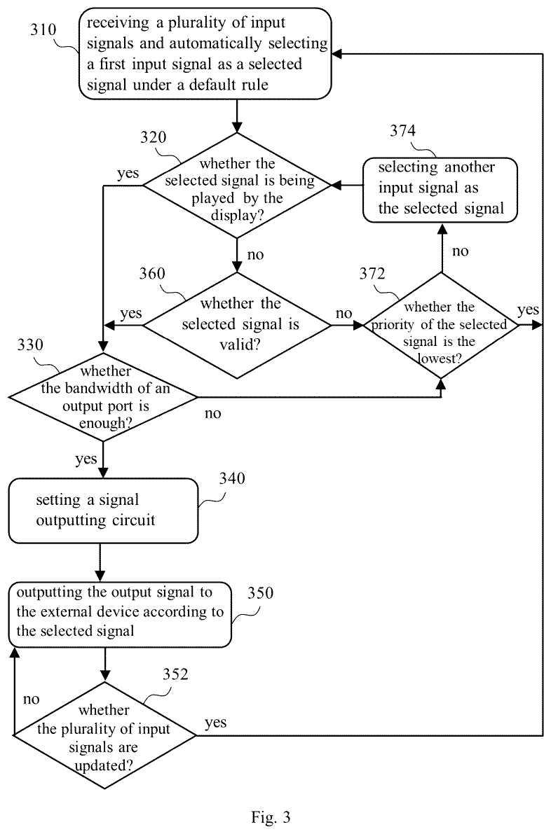

FIG. 3 shows another embodiment of the method of the present disclosure. This embodiment is performed by a display (e.g., the first display 110 in FIG. 1), which can select from a plurality of input signals (e.g., the N input signals S₁˜S_{N} in FIG. 1) to output an output signal (e.g., S₂ in FIG. 1) to an external device (e.g., the second display 120 in FIG. 1). As shown in FIG. 3, this embodiment includes the following steps:
S310: receiving the plurality of input signals with a plurality of input ports respectively, and automatically selecting a first input signal from the plurality of input signals as a selected signal to be or to be converted into the output signal under a default rule.
   In an implementation example, the content of the default rule is determined by implementation needs, which can be realized with firmware. In an implementation example, the priority of the first input signal is the highest priority among all priorities of the plurality of input signals, and is therefore the first input signal is selected as the selected signal under the default rule; in other words, the default rule determines the priorities of the plurality of input signals. In an implementation example: the default rule determines the priorities of the plurality of input ports, thereby determining the priorities of the plurality of input signals received by the plurality of input ports respectively; or the default rule determines the priorities of the plurality of input signals according to their formats/characteristics/compatibilities.
S320: determining whether the selected signal is being played by the display; if so, going to step S330; if not, going to step S360.
S330: determining whether the bandwidth of an output port of the display is enough, wherein the output port is used to be physically coupled to the external device; if so, going to step S340; if not, going to step S372.
S340: setting a signal outputting circuit according to the format of the selected signal and the specification of the output port.
S350: After the signal outputting circuit is set, using the signal outputting circuit to output the output signal to the external device through the output port according to the selected signal.
S352: After step S350, detecting whether the first input signal (i.e., the previously selected signal) is removed or a new input signal is received and accordingly generating a change-detection result; if the change-detection result is negative (that is: the first input signal is not removed and no new input signal is received), returning to step S350 to make the signal outputting circuit keep outputting the output signal to the output port according to the first input signal (i.e., the previously selected signal); and if the change-detection result is positive (That is: the first input signal is removed and/or a new input signal is received), returning to step S310 to select again from the plurality of input signals under the default rule.
   In an implementation example, step S352 determines that the priority of the new input signal is higher than the priority of the previously selected signal; therefore, step S352 returns to step S310 to make a new selection.
S360: determining whether the selected signal is valid; if so, going to S330; if not, going to S372.
S372: determining whether the priority of the selected signal is the lowest priority among all priorities of the plurality of input signals; if so, going back to step S310; if not, going to step S374.
   In an implementation example, after returning to step S310 from step S372, step S310 selects again from the plurality of input signals under the default rule to select an input signal of the highest priority for re-confirmation. In an implementation example, after returning to step S310 from step S372, step S310 selects again from the plurality of input signals under the default rule while the plurality of input signals may have changed.
S374: selecting another input signal from the plurality of input signals as the selected signal to be or to be converted into the output signal, wherein the priority of the another input signal is lower than the priority of the previously selected signal (i.e., the first input signal).
   It is noted that each step in FIG. 3 alone can be implemented by known or self-developed technologies, and thus its details are omitted here to avoid redundancy.

It is noted that a person having ordinary skill in the art can appreciate that the technical features of the embodiment of FIG. 2 can be reasonably applied to the embodiment of FIG. 3, and therefore, repeated and redundant descriptions are omitted here.

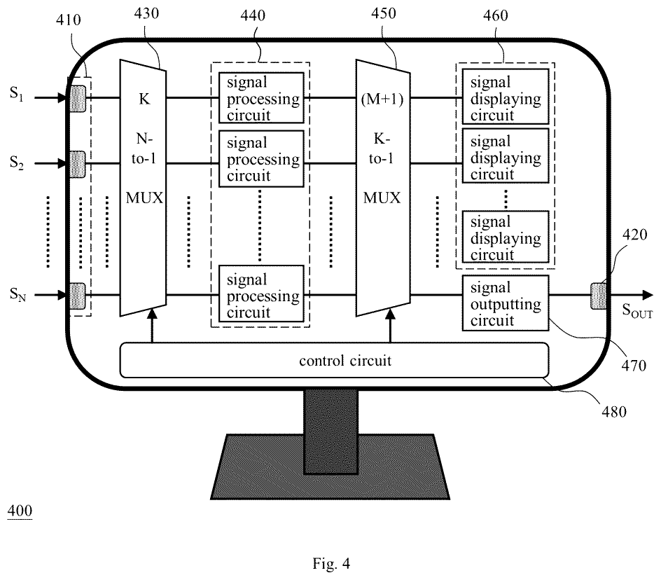

FIG. 4 shows an embodiment of the display (e.g., the display 110 in FIG. 1) of the present disclosure. This embodiment can perform the method of the present disclosure to select from N input signals S₁˜S_{N} to output an output signal S_{OUT} to an external device (e.g., the display 120 in FIG. 1), wherein the N is an integer equal to or greater than two. As shown in FIG. 4, the display 400 includes N input ports 410, at least one output port including a first output port 420, K N-to-1 multiplexers 430, K signal processing circuits 440, (M+1) K-to-1 multiplexers 450, M signal displaying circuits 460, a signal outputting circuit 470, and a control circuit 480.

Referring to FIG. 4, the N input ports 410 are configured to receive the N input signals S₁˜S_{N} respectively. The first output port 420 is configured to be physically coupled to the external device. The K N-to-1 multiplexers 430 are coupled to the N input ports 410 and configured to select X input signal(s) (e.g., S₁ and S_{N}) from the N input signals S₁˜S_{N}, wherein the K is an integer (e.g., K=N) equal to or greater than two, and the X is a positive integer equal to or less than the N. The K signal processing circuits 440 are coupled to the K N-to-1 multiplexers 430 respectively and configured to process the X input signal(s) to generate X signal(s), wherein the X signal(s) include(s) (X−1) locally-applied signal(s) (e.g., a signal derived from S₁) and a selected signal (e.g., a signal derived from S_{N}) that is used as the output signal S_{OUT} or the material for generating the output signal S_{OUT}, wherein the selected signal could be one of the (X−1) locally-applied signal(s) or be different from any of the (X−1) locally-applied signal(s). The (M+1) K-to-1 multiplexers 450 are coupled to the K signal processing circuits 440, the (M+1) K-to-1 multiplexers 450 configured to output the (X−1) locally-applied signal(s) to (X−1) signal displaying circuit(s) of the M signal displaying circuit(s) 460 and further configured to output the selected signal to the signal outputting circuit 470, wherein the M is a positive integer (e.g., M=N). The M signal displaying circuit(s) 460, which includes the (X−1) signal displaying circuit(s), are coupled to M multiplexer(s) of the (M+1) K-to-1 multiplexers 450 respectively, wherein the (X−1) signal displaying circuit(s) is/are configured to show frame(s) on a screen of the display according to the (X−1) locally-applied signal(s). The signal outputting circuit 470 is coupled to one of the (M+1) K-to-1 multiplexers 450 and configured to output the output signal S_{OUT} to the first output port 420 according to the selected signal. The control circuit 480 is configured to control the K N-to-1 multiplexers 430 and the (M+1) K-to-1 multiplexers 450 according to a user command or under a default rule and thereby select an input signal (e.g., S_{N}) from the N input signals as the selected signal to be or to be converted into the output signal S_{OUT}. Depending on implementation needs, the control circuit 480 can control at least one of the K signal processing circuits 440, the M signal displaying circuit(s) 460, and the signal outputting circuit 470 to make settings or choose at least one spare circuit from the above-mentioned circuits for utilization.

Since those having ordinary knowledge in the art can refer to the description of the method embodiments of FIGS. 2-3 to deduce the details and modifications of the display 400 of FIG. 4, repetitive and redundant descriptions are omitted here.

It is noted that if an implementation is possible, people having ordinary skill in the art can selectively implement some or all of the technical features in any of the foregoing embodiments or selectively implement a combination of some or all of the technical features in several of the foregoing embodiments to implement the present invention.

To sum up, the method and display of the present disclosure can independently select from a plurality of input signals to determine an output signal for an external device.

The aforementioned descriptions represent merely the preferred embodiments of the present invention, without any intention to limit the scope of the present invention thereto. Various equivalent changes, alterations, or modifications based on the claims of the present invention are all consequently viewed as being embraced by the scope of the present invention.

What is claimed is:

1. A method for selecting from a plurality of input signals to determine an output signal for an external device, the method comprising a plurality of steps performed by a display, wherein the plurality of steps include:
a first step including: receiving the plurality of input signals with a plurality of input ports of the display respectively, and receiving a user command designating a first input signal of the plurality of input signals as a selected signal to be or to be converted into the output signal;
a second step including: determining whether the display is displaying frame(s) according to the selected signal; and
a third step including: responsive to determining that the display is displaying the frame(s) according to the selected signal, executing at least one output step including:
in a circumstance that a bandwidth of an output port of the display is enough, executing subsidiary output steps including:
setting a signal outputting circuit of the display according to a format of the selected signal and a specification of the output port, wherein the output port is configured to be physically coupled to the external device; and
after setting the signal outputting circuit, using the signal outputting circuit to output the output signal to the output port according to the selected signal.

2. The method of claim 1, wherein the at least one output step further includes:
determining whether the bandwidth of the output port is enough; and
in a circumstance that the bandwidth of the output port is not enough, going back to the first step.

3. The method of claim 1, wherein the third step further includes:
responsive to determining that the display is not displaying the frame(s) according to the selected signal, executing detection steps including:
determining whether the selected signal is valid;
responsive to determining that the selected signal is valid, executing the at least one output step; and
responsive to determining that the selected signal is not valid, going back to the second step.

4. The method of claim 3, wherein the step of determining whether the output selected signal is valid includes:
using a hardware circuit of the display to detect the output selected signal and thereby generating a validity-detection result indicating whether the output selected signal is valid.

5. The method of claim 4, wherein the step of determining whether the selected signal is valid further includes: choosing a spare circuit from a plurality of candidate hardware circuits of the display as the hardware circuit.

6. The method of claim 1, wherein the first input signal is received by a first input port of the plurality of input ports, and a type of the first input port is different from a type of the output port.

7. The method of claim 6, wherein the step of using the signal outputting circuit to output the output signal to the output port according to the selected signal includes: converting a format of the first input signal to generate the output signal suitable for the type of the output port.

8. The method of claim 1, wherein the external device is another display.

9. A method for selecting from a plurality of input signals to determine an output signal for an external device, the method comprising a plurality of steps performed by a display, wherein the plurality of steps include:
a first step including: receiving the plurality of input signals by a plurality of input ports of the display respectively, and automatically selecting a first input signal from the plurality of input signals as a selected signal to be or to be converted into the output signal under a default rule;
a second step including: determining whether the display is displaying frame(s) according to the selected signal; and
a third step including: responsive to determining that the display is displaying the frame(s) according to the selected signal, executing at least one output step including:
in a circumstance that a bandwidth of an output port of the display is enough, executing subsidiary output steps including:
setting a signal outputting circuit of the display according to a format of the selected signal and a specification of the output port, wherein the output port is configured to be physically coupled to the external device; and
after the signal outputting circuit is set, using the signal outputting circuit to output the output signal to the output port according to the selected signal;
detecting whether the plurality of input signals is updated because the first input signal has been removed or a new input signal, as a part of the plurality of input signals, is received by the display, and accordingly generating a change-detection result;
when the change-detection result indicates that the plurality of input signals is not updated, making the signal outputting circuit keep outputting the output signal to the output port according to the selected signal; and
when the change-detection result indicates that the plurality of input signals is updated, going back to the first step.

10. The method of claim 9, wherein a priority of the new input signal is higher than a priority of the first input signal and thus the change-detection result indicates that the plurality of input signals is updated.

11. The method of claim 9, wherein the priority of the first input signal is a highest priority among all priorities of the plurality of input signals under the default rule.

12. The method of claim 9, wherein the at least one output step further includes:
determining whether the bandwidth of the output port is enough; and
in a circumstance that the bandwidth of the output port is not enough, executing reselection steps including:
determining whether a priority of the selected signal is a lowest priority among all priorities of the plurality of input signals;
responsive to determining that the priority of the selected signal is the lowest priority, going back to the first step; and
responsive to determining that the priority of the selected signal is not the lowest priority, automatically selecting another input signal from the plurality of input signals as the selected signal under the default rule, wherein a priority of the another input signal is lower than the priority of the first input signal.

13. The method of claim 9, wherein the third step further includes:
responsive to determining that the display is not displaying the frame(s) according to the selected signal, executing detection steps including:
determining whether the selected signal is valid;
responsive to determining that the selected signal is valid, executing the at least one output step; and
responsive to determining that the selected signal is not valid, executing reselection steps including:
determining whether a priority of the selected signal is a lowest priority among all priorities of the plurality of input signals;
responsive to determining that the priority of the selected signal is the lowest priority, going back to the first step; and
responsive to determining that the priority of the selected signal is not the lowest priority, automatically selecting another input signal from the plurality of input signals as the selected signal under the default rule, wherein a priority of the another input signal is lower than the priority of the first input signal.

14. The method of claim 13, wherein the step of determining whether the selected signal is valid includes: using a hardware circuit of the display to detect the selected signal and thereby generating a validity-detection result indicating whether the selected signal is valid.

15. The method of claim 14, wherein the step of determining whether the selected signal is valid further includes: choosing a spare circuit from a plurality of candidate hardware circuits of the display as the hardware circuit.

16. The method of claim 9, wherein the first input signal is received by a first input port of the plurality of input ports, and a type of the first input port is different from a type of the output port.

17. The method of claim 16, wherein the step of using the signal outputting circuit to output the output signal to the output port according to the selected signal includes: converting a format of the first input signal to generate the output signal suitable for the type of the output port.

18. The method of claim 9, wherein the external device is another display.

19. A display for selecting from N input signals to determine an output signal for an external device, the display comprising:
N input ports configured to receive the N input signals respectively, wherein the N is an integer equal to or greater than two;
at least one output port including a first output port, wherein the first output port is configured to be physically coupled to the external device;
K N-to-1 multiplexers coupled to the N input ports and configured to select X input signal(s) from the N input signals, wherein the K is an integer equal to or greater than two, and the X is a positive integer equal to or less than the N;
K signal processing circuits coupled to the K N-to-1 multiplexers respectively and configured to process the X input signal(s) to generate X signal(s), wherein the X signal(s) include(s) (X−1) locally-applied signal(s) and a selected signal that is used as the output signal or a material for generating the output signal;
(M+1) K-to-1 multiplexers coupled to the K signal processing circuits, the (M+1) K-to-1 multiplexers configured to output the (X−1) locally-applied signal(s) to (X−1) signal displaying circuit(s) of M signal displaying circuit(s) of the display and output the selected signal to a signal outputting circuit of the display, wherein the M is a positive integer;
the M signal displaying circuit(s) including the (X−1) signal displaying circuit(s), wherein the (X−1) signal displaying circuit(s) is/are configured to show frame(s) on a screen of the display according to the (X−1) locally-applied signal(s);
the signal outputting circuit configured to output the output signal to the first output port according to the selected signal; and
a control circuit configured to control the K N-to-1 multiplexers and the (M+1) K-to-1 multiplexers according to a user command or a default rule and thereby select one of the N input signals as the selected signal.

20. The display of claim 19, wherein the external device is another display.
